(19) United States
(12) Patent Application Publication
(10) Pub. No.: US 2026/0329449 A1
(43) Pub. Date: Oct. 22, 2026

(54) Efficient Jumbo Block Data Relocation

(71) Applicant: Sandisk Technologies, Inc., Milpitas, CA (US)

(72) Inventors: Marina FRID, Jerusalem (IL); Vered KELNER, Gan Haim, IL (US); Igor GENSHAFT, Bat Yam (IL)

(73) Assignee: Sandisk Technologies, Inc., Milpitas, CA (US)

(21) Appl. No.: 19/180,656

(22) Filed: Apr. 16, 2025

(51) Int. Cl. G06F 3/06

(52) U.S. Cl. CPC G06F 3/0614; G06F 3/064; G06F 3/0679

(57) ABSTRACT

By concentrating on the property of each jumbo block (JB), a controller in a data storage device can separate full JBs that contain only valid data from JBs that are partially invalid. The controller compares the valid count (VC) for the JBs to the JB size. If the VC is equal to the JB size, then the JB contains only valid data. If the JB is full, but VC is not equal to the JB size but still greater than zero, then the JB contains invalid data. The valid data in JBs with a VC less than the JB size can be moved to other JBs that are either not yet full or newly allocated from a free JB pool. In so doing, relocating data from JBs that are fully valid is avoided.

### BACKGROUND OF THE DISCLOSURE

### Field of the Disclosure

Embodiments of the present disclosure generally relate to improved data relocation.

### Description of the Related Art

A host device can create and delete namespaces (NSs). The creation and deletion is transparent for flash management except for format nonvolatile memory (FNVM) with user data erase (UDE) commands. If there are several NSs, the data storage device can receive read and write commands for the NSs. One command arrives for a first NS, another command arrives for a second NS, and so on. If a FNVM with UDE is needed, the data storage device will need to relocate valid data and physically erase invalid data from all blocks for a NS that is being relocated. The data validity is tracked with a valid mapping using a logical to physical (L2P) mapping table.

The problem with valid mapping is that the data storage device can write the same flash management unit (FMU) to a first jumbo block and then write an update to the same FMU to a second jumbo block so that the FMU in the first jumbo block is invalid and should be removed during a FNVM with UDE process. However, the data storage device does not track the invalid FMU in the first jumbo block because the data storage device does not maintain mapping history for erased data.

It is possible to perform a relocation from a source block and erase the source block after the relocation. For multiple source block relocations, the data storage device may time out because the relocation and erasing is a very long operation for all blocks in the data storage device. If the data storage device times out or an ungraceful shutdown (UGSD) occurs, the data storage device cannot continue the FNVM because at the end of block relocation, the data storage device performs a control sync operation. Thus, if performing relocation for fifteen blocks, there will be fifteen control sync operations, which takes time.

Therefore, there is a need in the art for improved data relocation.

### SUMMARY OF THE DISCLOSURE

By concentrating on the property of each jumbo block (JB), a controller in a data storage device can separate full JBs that contain only valid data from JBs that are partially invalid. The controller compares the valid count (VC) for the JBs to the JB size. If the VC is equal to the JB size, then the JB contains only valid data. If the JB is full, but VC is not equal to the JB size but still greater than zero, then the JB contains invalid data. The valid data in JBs with a VC less than the JB size can be moved to other JBs that are either not yet full or newly allocated from a free JB pool. In so doing, relocating data from JBs that are fully valid is avoided.

In one embodiment, a data storage device comprises: a memory device; and a controller coupled to the memory device, wherein the controller is configured to: determine that a full source JB has invalid data and valid data; move the valid data to a destination JB; and place the source JB into a free JB pool.

In another embodiment, a data storage device comprises: a memory device; and a controller coupled to the memory device, wherein the controller is configured to: determine that one or more first JBs have a VC that is less than a JB size, wherein the one or more first JBs are full; determine that one or more second JBs have a VC equal to a JB size, wherein the one or more second JBs are full; move valid data from the one or more first JBs to one or more destination JBs; and reduce the VC counter of the one or more first JBs to zero.

In another embodiment, a data storage device comprises: means to store data; and a controller coupled to the means to store data, wherein the controller is configured to: separate full JBs that contain valid data from full JBs that contain a mix of valid data and invalid data; move all valid data from the full JBs that contain a mix of valid data and invalid data, wherein all of the valid data is moved to one or more destination blocks; and reduce a VC of the full JBs from which all valid data has been moved.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic illustration of host created namespaces (NSs) according to one embodiment.

FIG. 3 is a schematic illustration of multiple jumbo blocks having one or more NSs that have been deallocated according to one embodiment.

FIG. 4 is a schematic illustration of jumbo block statuses before a format nonvolatile memory (FNVM) process according to one embodiment.

FIG. 5 is a schematic illustration of jumbo block statuses after a FNVM process according to one embodiment.

FIG. 6 is a flowchart illustrating valid jumbo block formation and deallocation according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

By concentrating on the property of each jumbo block (JB), a controller in a data storage device can separate full JBs that contain only valid data from JBs that are partially invalid. The controller compares the valid count (VC) for the JBs to the JB size. If the VC is equal to the JB size, then the JB contains only valid data. If the JB is full, but VC is not equal to the JB size but still greater than zero, then the JB contains invalid data. The valid data in JBs with a VC less than the JB size can be moved to other JBs that are either not yet full or newly allocated from a free JB pool. In so doing, relocating data from JBs that are fully valid is avoided.

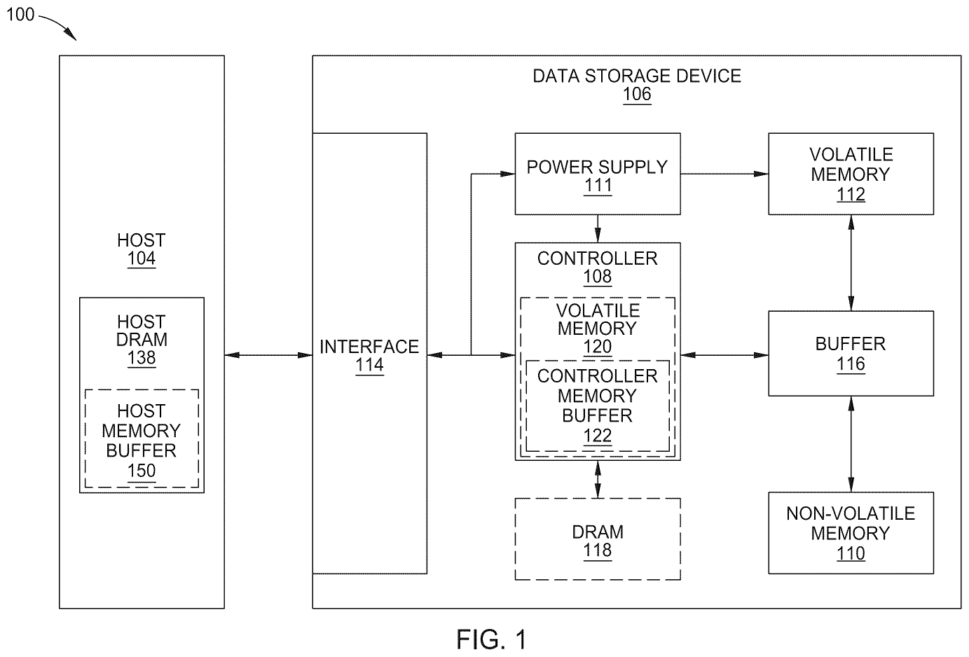

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe ×1, ×4, ×8, ×16, PCle Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

According to NVMe specification, a namespace (NS) is a formatted quantity of non-volatile memory (NVM) that may be accessed by a host device. Associated with each NS is an input/output (I/O) command set that operates on that NS. An NVMe controller may support multiple NSs that are referenced using a NS identification (NSID). NS may be created and deleted using the NS management and capacity management commands. The identify NS data structure, the I/O command set specific identify NS data structure, and the I/O command set independent identify NS data structure indicate capabilities and settings that are specific to a particular NS.

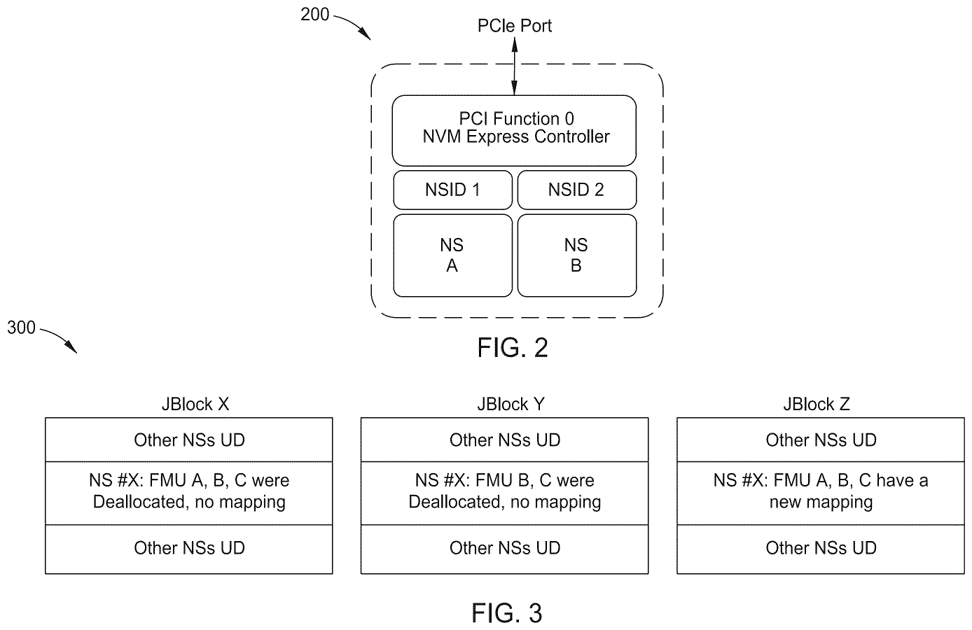

FIG. 2 is a schematic illustration of host created NSs 200 according to one embodiment. As shown in FIG. 2, the host device has created NS A and NS B through the NVMe controller using the PCI function. NS A and NS B are identified by NSID 1 and NSID 2.

A sanitize or format NVM (FNVM) command may destroy all data and metadata associated with all NSs or only the specific NS associated with the FNVM command. After a sanitize or FNVM command completes, the controller shall not return any user data previously contained in an affected NS. As part of the FNVM command, the host device requests a format operation and may request a secure erase of the contents of the NVM. The User Data Erase (UDE) command erases all user content present in the NVM subsystem.

It is to be noted that the flash translation layer (FTL) does not maintain a history of invalid flat FMU logical block addresses (FFLBAs). UDE in multiple NSs should guarantee erase of the NS #X “new” data (with valid mapping) and “old” data (without mapping) that might be physically located in several JBs after re-writing or deallocate user device (UD) NS #X.

FIG. 3 is a schematic illustration 300 of multiple jumbo blocks having one or more NSs that have been deallocated according to one embodiment. FIG. 3 shows the JB status before format, and there are blocks with data for several NSs. If there is a need to format a NS, there are blocks without NS and blocks with NSs and blocks with new mapping and blocks with old mapping. More particularly with regards to FIG. 3, there are three JBs shows: JBlock X, JBlock Y, and JBlock Z. Each JB has other NSs UD. JBlock X has data for NS #X for which FMUs A, B, and C were deallocated and there is no mapping. Similarly, JBlock Y has data for NS #X for which FMUs B and C were deallocated and there is no mapping. Finally, JBlock Z has data for NS #X for which FMUs A, B, and C have new mapping.

A problem is how to define JBs which should be relocated including JBs which can contain NS #X “old” data when the FTL doesn't have any mapping for “old” data location. For creating such “old” user data mapping, the FTL should scan all media and check each FMU metadata comparing to NS #X LBA-range.

To perform a relocation of NS X, the data storage device can logically remove the data and deallocate. To have a VC, the data storage device will need to perform a control sync operation. So for each block the controller can know there is a VC in the block as JB size so all the data is valid. Thus, the data storage device can say the block doesn't contain NS X because NS X was removed logically, but the data storage device cannot know if the JB had NS X removed, or some other data removed. To perform a relocation, the data storage device can start with all blocks with NS that do not equal JB size. If there is invalid FMUs, the relocation is performed until the status is that all JBs have a VC equal to the JB size after relocation.

Another problem is the need to continue relocation (RLC) handling with the last log in the current log JB because the FTL cannot roll back to see too many previous logs. Control Sync (CS) should be executed and completed at FNVM starting. NS FNVM with UDE requires many RLCs in a multi-NS system, resulting in many CSs due to a closed block RLC destination. From above, the current log is not the log at FNVM starting, which probably doesn't exist in the current JB log, and the second log block containing the FNVM startup log has been erased/overwritten. The problem is how to continue UDE Format NVM of one NS when a RLC process was interrupted by an ungraceful shutdown (UGSD).

There is an assumption to be made in performing an improved data relocation process. Sanitize/FNVM may destroy all data and metadata associated with all NSs or only the specific NS associated with the command. The UDE erases all user content present in the NVM subsystem. FTL should add a solution for FNVM with UDE for the specific NS. The message contains the type of NS FNVM with UDE and additional parameters within the message structure to indicate payload such as: a deallocate message that contains the NS range as FFLBA; and length. UDE (FNVM_UDE_DATA_ERASE) destroys all data and metadata associated with all NS or only the specific NSs.

The proposed algorithm for the NS FNVM with UDE is the following. First, when all VCs in NS #X LBA range mappings are synchronized after deallocation (FNVM_STATE_SNS_DALOC state) of NS #X LBA range with forced VC synchronization of each touched mSet and forced CS when all touched mSets are synchronized, the FTL guarantees that no valid mSets contain NS #X LBA range mappings; and no fully valid JB (all valid VCs) contains any FMU from NS #X LBA range mappings. Therefore, there is no need for RLC of fully valid JBs, and RLC due to FNVM is triggered until all JBs are valid.

Secondly, the above also solves the following problems: continuing the FNVM RLC process after many CSs and many GSD/UGSD; saving FNVM type and current state in the log at each control synchronization ensures that the FNVM RLC process continues from the last RLC step after many CSs and many GSD/UGSD; convergence of the algorithm; and minimizing the number of JB RLCs as much as possible.

There are additional advantages: no additional algorithm for the FTL mapping table erase (uLayer & mLayer of NS #X are erased after deallocating the NS with forced VC synchronization and CS at the end FNVM_STATE_SNS_DALOC state; and no RLC mechanism changes, only FNVM trigger for start/continue RLC.

Generally speaking, the FTL cannot distinguish between invalid NS #X FMUs and invalid FMUs from other NSs, so only fully valid JBs (after NS #X Deallocation and VC synchronization) can skip the RLC if UDE is required.

Based upon the instant disclosure, the data storage device can continue FNVM after a GSD/UGSD event because there is a trigger to continue the relocation if the relocation is not completed. For example, if there is threshold set for FNVM to be for one hundred locations, after 100 relocations the data storage device will do a reset. Thereafter, the data storage device can continue at the same point and continue with the next relocation without needing to do a rollback. The data storage device can continue from the exact location where the reset occurred.

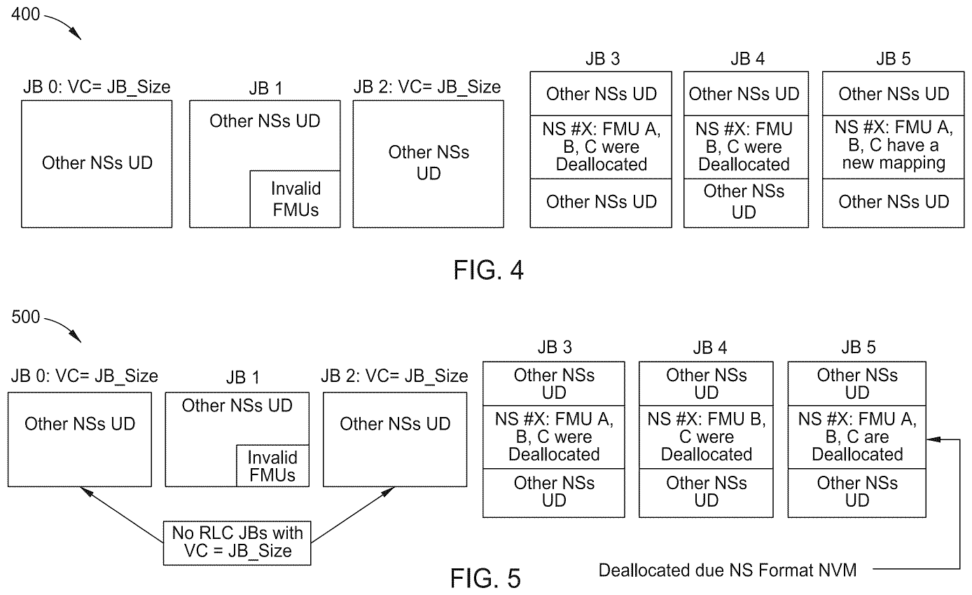

FIG. 4 is a schematic illustration 400 of JB statuses before a format nonvolatile memory (FNVM) process according to one embodiment. On FNVM_STATE_SNS_DALOC state, execute deallocation of the NS LBA range with forced VC synchronization of each touched mSet of all NS #X LBA range mappings. FIG. 5 is a schematic illustration 500 of JB statuses after a FNVM process according to one embodiment. Do control sync in blocking mode to keep the FTL tables up to date and update the FNVM state in log, when the NS LBA range is logically deallocated. Trigger RLC for each JB that has at least one invalid VC.

The algorithm also solves the following problems: continuing the FNVM RLC process after many CSs and many GSD/UGSD; convergence of the algorithm; and minimizing the number of JB RLCs as much as possible. The additional advantages include: no additional algorithm for FTL mapping table erase (uLayer & mLayer of NS #X are erased after deallocate NS with forced VC synchronization and forced CS when entire process of VC synchronization is completed; no RLC mechanism changes, only FNVM trigger for start/continue RLC; and minimal code changes.

More specifically with regards to FIGS. 4 and 5, the JBs 0, 1, and 2 do not have any data related to the NS that is being relocated. After arranging the VCs, JBs 0, 1, and 2 are entirely valid and there is no reason to relocate them. Now looking at JB 3, it can be seen that in the middle there are a few FMUs related to the NS that is being relocated and has been deallocated. Because of the deallocation, JB 3 has some invalid FMUs, so JB 3 is eligible for relocation. To perform the relocation, the controller will allocate a new JB, JB 6, which is a free JB. The controller will copy all the valid data from JB 3 to JB 6. JB 3 now becomes free and JB 6 will contain on only the valid data. JB 6 may or may not be full, but JB 6 contains only the valid data.

If JB 6 is not full after the relocation of the valid data from JB 3, JB 6 can be filled with valid data from other locations. For example, JB 4 can also have valid data relocated because JB 4 has a few FMUs that are related to the NS that is being relocated and has been deallocated. The process can repeat until gradually JB 6 is filled, and JB 6 contains only valid data. If at this point there is a UGSD event, then after the power up following the UGSD the controller can continue along and skip any blocks that are totally valid. The controller will skip the JB 6 and thus gradually there is a decrease in the amount of data that has to be relocated. Also, despite the UGSDs, every time the controller will get closer and closer to the end of the process where only valid data is in JBs so that the process finally will be completed.

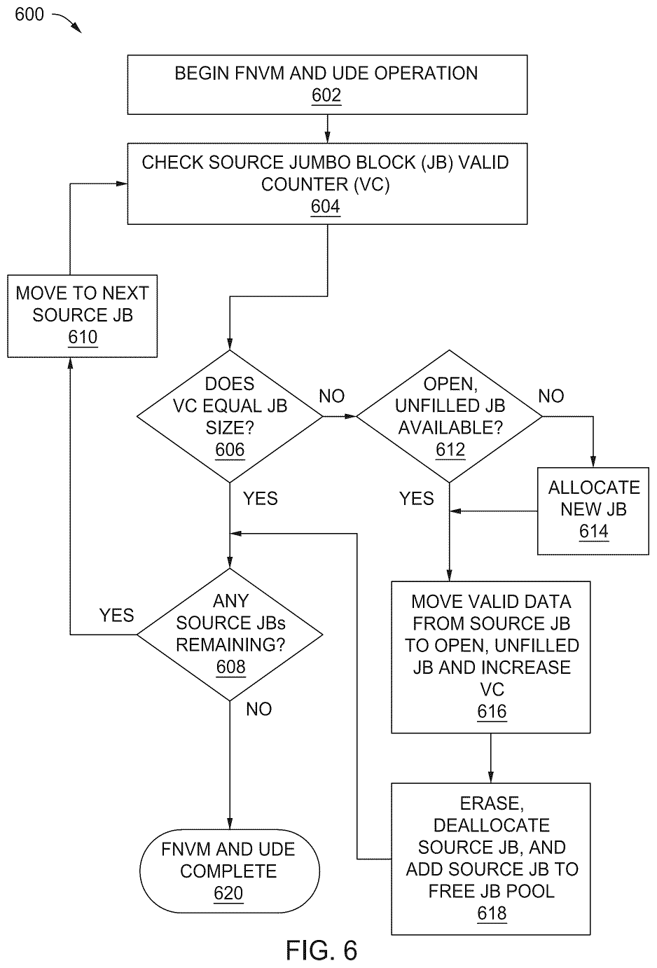

FIG. 6 is a flowchart 600 illustrating valid JB formation and deallocation according to one embodiment. Generally speaking, the process involves concentrating on the properties of each JB to separate JBs that are fully valid from JBs that are partially invalid. The main point of FIG. 6 is concentrating on the property of each JB and separate the JBs that are totally valid from the JBs that are partially invalid.

Initially, a FNVM and UDE operation begins at block 602. The operation may begin due to the controller starting the operation due to receiving a FNVM and UDE command or after a GSD/UGSD that occurred while processing a FNVM and UDE command or simply because a threshold has passed without checking to see if any data relocation would be valuable.

A full JB (i.e., source JB) is checked to determine the VC at block 604 followed by a determination of whether VC is equal to JB size at block 606. If VC is equal to JB size, then the JB is full of valid data and no relocation is to occur. A determination is made at block 608 regarding whether there are any additional full JBs to check. If there are no additional full JBs to check, then the FNVM and UDE operation is complete at block 620. However, if there are additional full JBs to check, then the controller moves to the next JB at block 610 followed by a return to block 604.

If VC does not equal JB size at block 606, then there is invalid data in the JB. The controller then determines whether there are any already open, allocated, and unfilled JBs available for data transfer as a destination JB at block 612. If there are no such destination JBs, then a new destination JB is allocated at block 614 followed by moving the valid data from the source JB to the new JB at block 616. The VC counter for the new destination block is increased, and the corresponding VC counter for the source JB is decreased. The increase should be equal to the decrease. If there are open, allocated, and unfilled JBs at block 612, then the method proceeds to block 616 where the data is moved from the source JB to the destination JB that was already open, allocated, and unfilled. The VC of the destination JB is increased and the VC of the source JB is correspondingly decreased. Thereafter, the source JB should have VC equal to zero and is then erased, deallocated, and added to a free JB pool to be available for future allocate at block 618. Thereafter, the process proceeds to block 608.

Thus, what ultimately occurs is JBs are routinely written to by the controller. As valid data is written to a JB, the VC increases up to a maximum level of VC equal to the JB size. At any time, data in the JB may be rendered invalid. When data in a JB is rendered invalid, then the VC decreases. The VC may, theoretically, never reach a value equal to JB size because as the JB is filling, some of the data already in the JB may be rendered invalid. In any event, the VC will increase as data is added to the JB, and the VC will decrease as data is rendered invalid. The maximum value for VC is equal to JB size. Any time a JB is known to be full, but VC does not equal JB size, then the JB has invalid data therein. In such a scenario, data relocation may be beneficial to move the valid data from the JB (i.e., source JB) to a destination JB so that the destination JB has only valid data therein. The source JB would then be erased, deallocated, and placed in a free JB pool for allocation as a new JB or destination JB. The data relocation for the JB is discussed above with regards to FIG. 6.

By relocating data from JBs that have both valid and invalid data, and skipping over JBs that have only valid data, the disclosure will solve the problem of sanitize/FNVM with UDE for specific NSs in a multiple NS system. Thus, data relocation is improved.

In one embodiment, a data storage device comprises: a memory device; and a controller coupled to the memory device, wherein the controller is configured to: determine that a full source jumbo block (JB) has invalid data and valid data; move the valid data to a destination JB; and place the source JB into a free JB pool. The determining comprises comparing a valid counter (VC) for the source JB to a JB size of the source JB. The VC is less than the JB size. The controller is configured to increase the VC for the destination JB. The controller is configured to reduce the VC for the source JB. The controller is configured to not move valid data for JBs having a VC equal to a JB size. The determining is in response to receiving a format nonvolatile memory (FNVM) user data erase (UDE) command. The determining is in response to an ungraceful shutdown (UGSD) event. The controller is configured to repeat the determining for at least one additional JB. The destination JB already has valid data therein when the moving occurs.

In another embodiment, a data storage device comprises: a memory device; and a controller coupled to the memory device, wherein the controller is configured to: determine that one or more first jumbo blocks (JBs) have a valid counter (VC) that is less than a JB size, wherein the one or more first JBs are full; determine that one or more second JBs have a VC equal to a JB size, wherein the one or more second JBs are full; move valid data from the one or more first JBs to one or more destination JBs; and reduce the VC counter of the one or more first JBs to zero. The one or more first JBs contain invalid data and valid data. The controller is configured to deallocate the one or more first JBs. The controller is configured to perform a control sync operation prior to moving the valid data and after the determining that the one or more first JBs have a VC that is less than a JB size. The controller is configured to deallocate namespace (NS) data in the one or more first JBs prior to the determining that the one or more first JBs have a VC that is less than a JB size. The controller is configured to repeat the determining that the one or more first JBs have a VC that is less than a JB size, the moving, and the reducing. The controller is configured to perform a shutdown event prior to the repeating.

In another embodiment, a data storage device comprises: means to store data; and a controller coupled to the means to store data, wherein the controller is configured to: separate full jumbo blocks (JBs) that contain valid data from full JBs that contain a mix of valid data and invalid data; move all valid data from the full JBs that contain a mix of valid data and invalid data, wherein all of the valid data is moved to one or more destination blocks; and reduce a valid count (VC) of the full JBs from which all valid data has been moved. The separating is based upon a comparison of the VC and JB size. The separating is in response to receiving a format nonvolatile memory (FNVM) user data erase (UDE) command.

While the foregoing is directed to embodiments of the present disclosure, other and further embodiments of the disclosure may be devised without departing from the basic scope thereof, and the scope thereof is determined by the claims that follow.

1. A data storage device, comprising:
a memory device; and
a controller coupled to the memory device, wherein the controller is configured to:
determine that a full source jumbo block (JB) has invalid data and valid data;
determine whether a valid count (VC) of the source JB is equal to a size of the source JB;
in response to determining that the VC is equal to the size of the source JB, skip the source JB and continue processing a next source JB;
in response to determining that the VC is less than the size of the source JB, move the valid data to a destination JB; and
place the source JB into a free JB pool.

2. The data storage device of claim 1, wherein the determining comprises comparing a valid counter (VC) for the source JB to a JB size of the source JB.

3. The data storage device of claim 2, wherein the VC is less than the JB size.

4. The data storage device of claim 2, wherein the controller is configured to increase the VC for the destination JB.

5. The data storage device of claim 2, wherein the controller is configured to reduce the VC for the source JB.

6. The data storage device of claim 2, wherein the controller is configured to not move valid data for JBs having a VC equal to a JB size.

7. The data storage device of claim 1, wherein the determining is in response to receiving a format nonvolatile memory (FNVM) user data erase (UDE) command.

8. A data storage device comprising:
a memory device; and
a controller coupled to the memory device, wherein the controller is configured to:
determine that a full source jumbo block (JB) has invalid data and valid data wherein the determining is in response to an ungraceful shutdown (UGSD) event;
move the valid data to a destination JB; and
place the source JB into a free JB pool.

9. The data storage device of claim 1, wherein the controller is configured to repeat the determining for at least one additional JB.

10. The data storage device of claim 1, wherein the destination JB already has valid data therein when the moving occurs.

11. A data storage device, comprising:
a memory device; and
a controller coupled to the memory device, wherein the controller is configured to:
determine that one or more first jumbo blocks (JBs) have a valid counter (VC) that is less than a JB size, wherein the one or more first JBs are full;
determine that one or more second JBs have a VC equal to a JB size, wherein the one or more second JBs are full;
skip relocation of valid data from the one or more second JBs in response to determining that the one or more second JBs have a VC equal to a JB size;
move valid data from the one or more first JBs to one or more destination JBs; and
reduce the VC counter of the one or more first JBs to zero.

12. The data storage device of claim 11, wherein the one or more first JBs contain invalid data and valid data.

13. The data storage device of claim 11, wherein the controller is configured to deallocate the one or more first JBs.

14. The data storage device of claim 11, wherein the controller is configured to perform a control sync operation prior to moving the valid data and after the determining that the one or more first JBs have a VC that is less than a JB size.

15. The data storage device of claim 11, wherein the controller is configured to deallocate namespace (NS) data in the one or more first JBs prior to the determining that the one or more first JBs have a VC that is less than a JB size.

16. The data storage device of claim 11, wherein the controller is configured to repeat the determining that the one or more first JBs have a VC that is less than a JB size, the moving, and the reducing.

17. A data storage device, comprising:
a memory device; and
a controller coupled to the memory device, wherein the controller is configured to:
determine that one or more first jumbo blocks (JBs) have a valid counter (VC) that is less than a JB size, wherein the one or more first JBs are full;
determine that one or more second JBs have a VC equal to a JB size, wherein the one or more second JBs are full;
move valid data from the one or more first JBs to one or more destination JBs; and
reduce the VC counter of the one or more first JBs to zero wherein the controller is configured to repeat the determining that the one or more first JBs have a VC that is less than a JB size, the moving, and the reducing, and wherein the controller is configured to perform a shutdown event prior to the repeating.

18. A data storage device, comprising:
means to store data; and
a controller coupled to the means to store data, wherein the controller is configured to:
separate full jumbo blocks (JBs) that contain valid data from full JBs that contain a mix of valid data and invalid data;
skip relocation of valid data from the full JBs having a valid count (VC) equal to a JB size;
move all valid data from the full JBs that contain a mix of valid data and invalid data, wherein all of the valid data is moved to one or more destination blocks; and
reduce a valid count (VC) of the full JBs from which all valid data has been moved.

19. The data storage device of claim 18, wherein the separating is based upon a comparison of the VC and JB size.

20. The data storage device of claim 18, wherein the separating is in response to receiving a format nonvolatile memory (FNVM) user data erase (UDE) command.
